(19) United States
(12) Patent Application Publication
(10) Pub. No.: US 2026/0138185 A1
(43) Pub. Date: May 21, 2026

(54) PLASMA TREATMENT OF JETTED SURFACES TO CREATE BREAK-AWAY SUPPORTS IN MAGNETOHYDRODYNAMIC PRINTING OF ALUMINUM

(71) Applicant: DESKTOP METAL, INC., Burlington, MA (US)

(72) Inventors: Graham W. CULLEN, Burlington, MA (US); Emanuel SACHS, Burlington, MA (US)

(21) Appl. No.: 19/119,775

(22) PCT Filed: Oct. 11, 2023
(86) PCT No.: PCT/US2023/034982

§ 371 Date: Apr. 10, 2025

Related U.S. Application Data
(60) Provisional application No. 63/415,211, filed on Oct. 11, 2022.

(51) Int. Cl. B22F 10/47; B22F 10/22; B33Y 10/00; B33Y 30/00

(52) U.S. Cl. CPC B22F 10/47; B22F 10/22; B33Y 10/00; B33Y 30/00; B22F 2301/052

(57) ABSTRACT

Methods and systems for forming break-away supports during additive manufacturing of objects via magnetohydrodynamic (MHD) jetting. In MHD jetting supports may be required for certain overhang areas and/or other features. On a surface or surfaces that will contact the object and/or a build plate (or the like), a plasma discharge may be conducted to create a treated surface. The treated surface bonds weakly with the support relative to inter-layer bonds between construction layers. Thus, after printing is complete the supports can be easily separated without strong mechanical forces that may have otherwise damaged the printed object.

### CROSS-REFERENCE TO RELATED APPLICATIONS

The present application is a US National Stage application, filed under 35 U.S.C. § 371, of International Application PCT/US2023/034982, filed Oct. 11, 2023, claims the benefit under 35 U.S.C. § 119(e) of U.S. Provisional Application No. 63/415,211, titled PLASMA TREATMENT OF JETTED SURFACES TO CREATE BREAK-AWAY SUPPORTS IN MAGNETOHYDRODYNAMIC PRINTING OF ALUMINUM, filed Oct. 11, 2022, the contents of which are herein incorporated by reference in their entirety.

### BACKGROUND

Controlled magnetohydrodynamic (MHD) pulsing may be used to selectively jet individual drops of molten metals and additively build up three-dimensional geometries, in a process known as magnetohydrodynamic printing (here referred to as MHD printing, or MHD). In one embodiment of this process, a jetting apparatus is employed to heat solid metal feedstock above its liquidus temperature to create molten metal; contain the molten metal; keep the molten metal above its liquidus temperature; position the body of molten metal relative to a magnetic field; enable an electric current to be passed through the molten metal to create a magnetohydrodynamic pulse; and direct the flow of molten metal towards a desired target.

In MHD, the technology is capable of printing overhangs at up to approximately a 45 degree angle from the vertical. However, any overhang that is steeper than this, (closer to the horizontal) will require supports. Further some parts have features that start above the build plate and hence must be spaced form from the build plate by supports.

Such supports, while required to achieve desired additively manufactured geometries, can be physically difficult to separate from the build surface and/or part surface after manufacturing. This may be particularly apparent where the same or very similar metal is used for both the underlying object and supports). In MHD, it would be most convenient if the supports were made of the same material as that jetted, obviating the need to jet or otherwise build with a second material, however, such materials, will tend to fuse together as do subsequent layers of the object. In addition, in MHD, the build volume and the molten metal droplets are at elevated temperatures, making the identification of a second material for supports challenging. The present disclosure aims to ameliorate one or more of the above identified problems.

### SUMMARY

Disclosed are systems and methods for formation of break-away supports for use in the additive manufacture of metallic objects. These are particularly suited for use with MHD jetting, and in certain instances may be employed with an aluminum or aluminum alloy build material.

A plasma forming electrode is used to treat a surface or surfaces such as the printing substrate or an area of the object being manufactured. A support formed from a material that can be the same or substantially similar to the build material is formed affixed at least at one distal end, for example, both distal ends, to treated surfaces. Following the completion of printing, the plasma treated areas provide break-away areas where the support is weakly connected and can be physically separated from the printing substrate or object with significantly less effort than if no plasma treatment was applied. The ease with such supports can be removed helps prevent physical damage to the object that may otherwise accompany forces required to dislodge such supports and leaves nothing behind.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments. The patent or application file contains at least one drawing executed in color. Copies of this patent or patent application publication with color drawing(s) will be provided by the Office upon request and payment of the necessary fee.

FIG. 1 is a block diagram of an additive manufacturing system for magnetohydrodynamic molten metal printing.

FIGS. 2A-C are depictions of the nozzle of the system of FIG. 1.

FIGS. 3A-B depict an embodiment jetting apparatus.

FIG. 4 depicts an embodiment plasma treatment.

FIG. 5 is a scanning electron microscope (SEM) image of an embodiment treated area for break-away supports.

FIG. 6 is another scanning electron microscope (SEM) image of an embodiment treated area for break-away supports.

FIG. 7 is another scanning electron microscope (SEM) image of an embodiment treated area for break-away supports.

FIGS. 8A-P depict the process of removing break-away supports following a printing operation.

FIG. 9 depicts the substrate of FIGS. 8A-P as cleared of supports.

FIG. 10 depicts a side view of a construction according to certain embodiments.

FIG. 11 depicts a side view of a construction having an overhang supported by columns.

FIG. 12 depicts a side view of a construction having a break-away surface.

Reference will now be made in detail to the exemplary embodiments of the present disclosure, examples of which are illustrated in the accompanying drawings. Wherever possible, the same reference numbers will be used throughout the drawings to refer to the same or like parts.

### DETAILED DESCRIPTION

Disclosed now is a non-limiting example of an additive manufacturing technology with which the present disclosure may be employed. It should be understood that other additive manufacturing technologies may be employed.

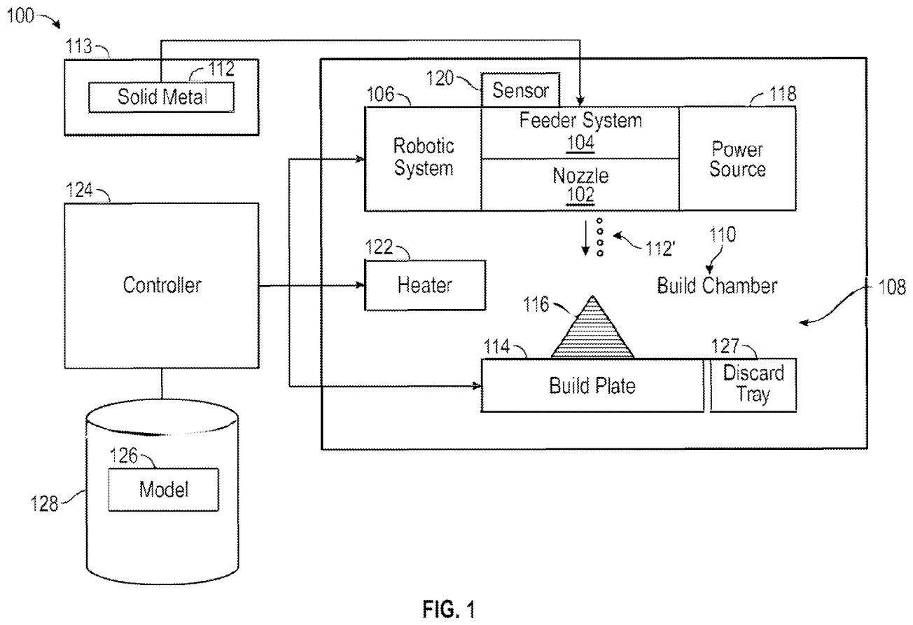

FIG. 1 is a schematic depiction of an additive manufacturing system 100 using MHD printing of liquid metal in which the disclosed improvements may be employed. Additive manufacturing system 100 can include a nozzle 102, a feeder system 104, and a robotic system 106. In general, the robotic system 106 can move the nozzle 102 along a controlled pattern within a working volume 108 of a build chamber 110 as the feeder system 104 moves a solid metal 112 from a metal supply 113 and into the nozzle 102. As described in greater detail below, the solid metal 112 can be melted via heater 122 in or adjacent to the nozzle 102 to form a liquid metal 112′ and, through a combination of a magnetic field and an electric current acting on the liquid metal 112′ in the nozzle 102, MHD forces can eject the liquid metal 112′ from the nozzle 102 in a direction toward a build plate 114 disposed within the build chamber 110.

Through repeated ejection of the liquid metal 112′ as the nozzle 102 moves along the controlled pattern, an object 116 (e.g., a two-dimensional object or a three-dimensional object) can be formed. The object may be formed based on a model 126 (stored on a sever 128) enacted through a controller 124. In certain embodiments, the object 116 can be moved under the nozzle 102 (e.g., as the nozzle 102 remains stationary). For example, in instances in which the controlled pattern is a three-dimensional pattern, the liquid metal 112′ can be ejected from the nozzle 102 in successive layers to form the object 116 through additive manufacturing. Thus, in general, the feeder system 104 can continuously, or substantially continuously, provide build material to the nozzle 102 as the nozzle 102 ejects the liquid metal 112′, which can facilitate the use of the three-dimensional printer 100 in a variety of manufacturing applications, including high volume manufacturing of metal parts. As also described in greater detail below, MHD forces can be controlled in the nozzle 102 to provide drop-on-demand delivery of the liquid metal 112′ at rates ranging from about one liquid metal drop per hour to thousands of liquid metal drops per second and, in certain instances, to deliver a substantially continuous stream of the liquid metal 112′. A sensor or sensors 120 may monitor the printing process as discussed further below.

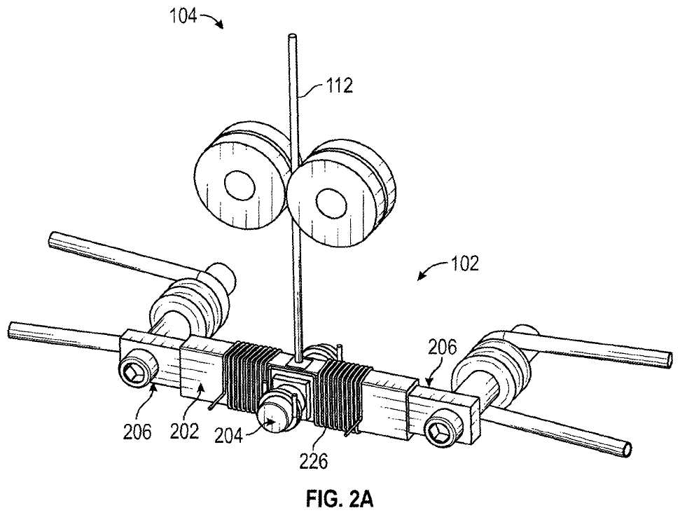

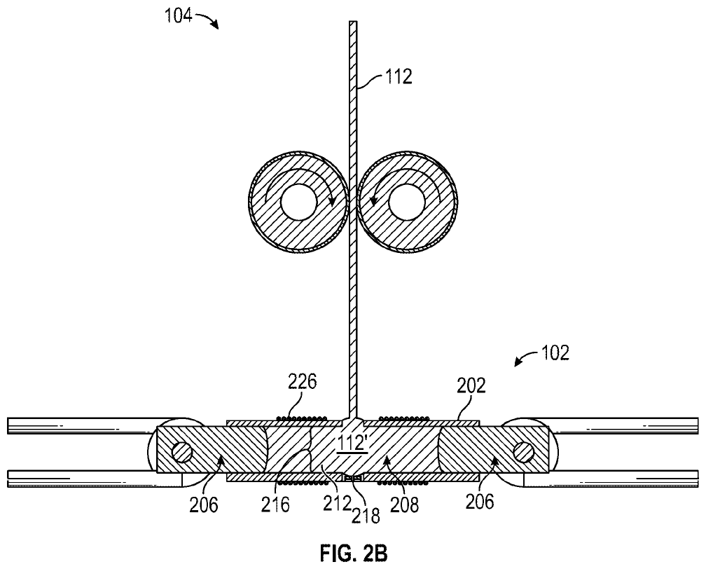

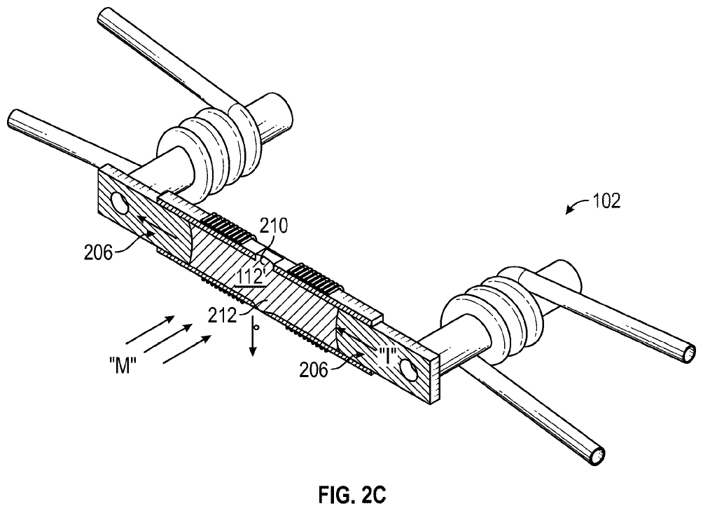

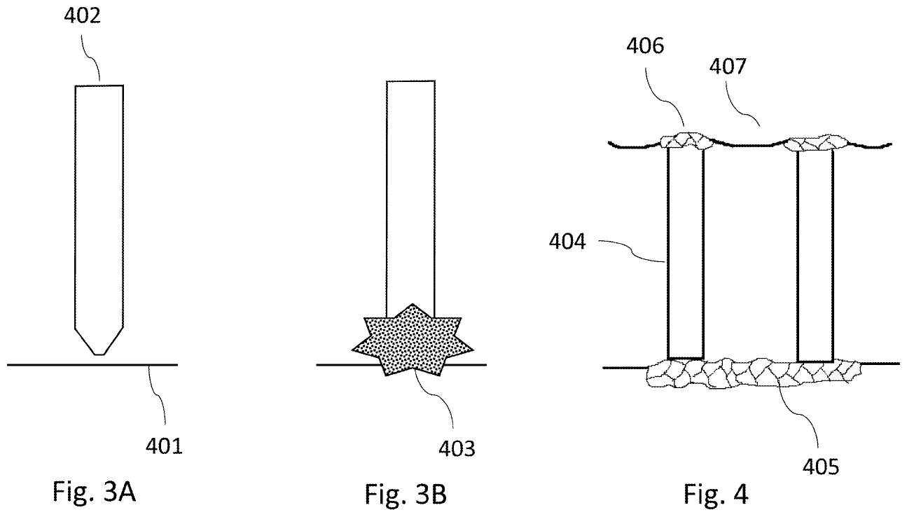

Now with reference to FIGS. 2A-C which depict the nozzle of the printer of FIG. 1. The nozzle can include a housing 202, one or more magnets 204, and electrodes 206. The housing 202 can define at least a portion of a fluid chamber 208 having an inlet region 210 and a discharge region 212. The one or more magnets 204 can be supported on the housing 202 or otherwise in a fixed position relative to the housing 202 with a magnetic field “M” generated by the one or more magnets 204 directed through the housing 202. In particular, the magnetic field can be directed through the housing 202 in a direction intersecting the liquid metal 112′ as the liquid metal 112′ moves from the inlet region 210 to the discharge region 212. Also, or instead, the electrodes 206 can be supported on the housing 202 to define at least a portion of a firing chamber 216 within the fluid chamber 208, between the inlet region 210 and the discharge region 212. In use, the feeder system 104 can engage the solid metal 112 and, additionally or alternatively, can direct the solid metal 112 into the inlet region 210 of the fluid chamber 208 as the liquid metal 112′ is ejected through the discharge orifice 218 through MHD forces generated using the one or more magnets 204 and the electrodes 206. A heater 226 may be employed to heat the housing 202 and the fluid chamber 208 to melt the solid metal 112. A discard tray 127 is located in proximity to the build plate and the nozzle may deposit droplets in it during a testing or calibration step.

In certain implementations, an electric power source 118 can be in electrical communication with the electrodes 206 and can be controlled to produce an electric current “I” lowing between the electrodes 206. In particular, the electric current “I” can intersect the magnetic field “M” in the liquid metal 112′ in the firing chamber 216. It should be understood that the result of this intersection is an MHD force (also known as a Lorentz force) on the liquid metal 112′ at the intersection of the magnetic field “M” and the electric current “I”. Because the direction of the MHD force obeys the right-hand rule, the one or more magnets 204 and the electrodes 206 can be oriented relative to one another to exert the MHD force on the liquid metal 112′ in a predictable direction, such as a direction that can move the liquid metal 112′ toward the discharge region 212. The MHD force on the liquid metal 112′ is of the type known as a body force, as it acts in a distributed manner on the liquid metal 112′ wherever both the electric current “I” is flowing and the magnetic field “M” is present. The aggregation of this body force creates a pressure which can lead to ejection of the liquid metal 112′. It should be appreciated that orienting the magnetic field “M” and the electric current substantially perpendicular to one another and substantially perpendicular to a direction of travel of the liquid metal 112′ from the inlet region 210 to the discharge region 212 can result in the most efficient use of the electric current “I” to eject the liquid metal 112′ through the use of MHD force.

In use, the electrical power source 118 can be controlled to pulse the electric current “I” flowing between the electrodes 206. The pulsation can produce a corresponding pulsation in the MHD force applied to the liquid metal 112′ in the firing chamber 216. If the impulse of the pulsation is sufficient, the pulsation of the MHD force on the liquid metal 112′ in the firing chamber 208 can eject a corresponding droplet from the discharge region 212.

In certain implementations, the pulsed electric current “I” can be driven in a manner to control the shape of a droplet of the liquid metal 112′ exiting the nozzle 102. In particular, because the electric current “I” interacts with the magnetic field “M” according to the right-hand rule, a change in direction (polarity) of the electric current “I” across the firing chamber 216 can change the direction of the MHD force on the liquid metal 112′ along an axis extending between the inlet region 210 and the discharge region 212. Thus, for example, by reversing the polarity of the electric current “I” relative to the polarity associated with ejection of the liquid metal 112′, the electric current “I” can exert a pullback force on the liquid metal 112′ in the fluid chamber 208.

Each pulse can be shaped with a pre-charge that applies a small, pullback force (opposite the direction of ejection of the liquid metal 112′ from the discharge region 212) before creating an ejection drive signal to propel one or more droplets of the liquid metal 112′ from the nozzle 102. In response to this pre-charge, the liquid metal 112′ can be drawn up slightly with respect to the discharge region 212. Drawing the liquid metal 112′ slightly up toward the discharge orifice in this way can provide numerous advantageous, including providing a path in which a bolus of the liquid metal 112′ can accelerate for cleaner separation from the discharge orifice as the bolus of the liquid metal is expelled from the discharge orifice, resulting in a droplet with a more well-behaved (e.g., stable) shape during travel. Similarly, the retracting motion can effectively spring load a forward surface of the liquid metal 112′ by drawing against surface tension of the liquid metal 112′ along the discharge region 212. As the liquid metal 112′ is then subjected to an MHD force to eject the liquid metal 112′, the forces of surface tension can help to accelerate the liquid metal 112′ toward ejection from the discharge region 212.

Further, or instead, each pulse can be shaped to have a small pullback force following the end of the pulse. In such instances, because the pullback force is opposite a direction of travel of the liquid metal 112′ being ejected from the discharge region 212, the small pullback force following the end of the pulse can facilitate clean separation of the liquid metal 112′ along the discharge region 212 from an exiting droplet of the liquid metal 112′. Thus, in some implementations, the drive signal produced by the electrical power source 118 can include a wavelet with a pullback signal to pre-charge the liquid metal 112′, an ejection signal to expel a droplet of the liquid metal, and a pullback signal to separate an exiting droplet of the liquid metal 112′ from the liquid metal 112′ along the discharge region 212. Additionally, or alternatively, the drive signal produced by the electrical power source 118 can include one or more dwells between portions of each pulse.

As used herein, the term “liquid metal” shall be understood to include metals and metal alloys in liquid form and, additionally or alternatively, includes any fluid-containing metals and metal alloys in liquid form, unless otherwise specified or made clear by the context. Metals suitable for use with the disclosure include aluminum and aluminum alloys, copper and copper alloys, silver and silver alloys, gold and gold alloys, platinum and platinum alloys, iron and iron alloys, and nickel and nickel alloys.

The present disclosure allows for break-away supports when using the same material for the supports and for the part, typically an aluminum alloy and in at least one embodiment, Alloy 4008 (or A356), although not limited to this alloy or to aluminum alloys more generally. The key is to create a treated layer at the interface between a support and the portion of the from which it is to break away. Without such a treatment, the interface between the part and the support is fused—welded—as in the part itself.

The treatment is accomplished by plasma discharge. An electrode, such as a 1/16″ diameter mixed-oxide tungsten electrode used in TIG welding, is positioned near the surface to be treated with a gap ranging from 0.7 to 1.3 mm 0.4 to 2.0 mm. A discharge is initiated with a high voltage pulse. It has been found that over a range of discharge conditions, that the surface of the aluminum becomes reticulated, or porous with features on the order of 0.1-10 microns.

FIGS. 4A-C depicts a side schematic view of an embodiment treatment. Supports 404 for an object being additively manufactured are desired to be attached to substrate 401. With reference to FIGS. 4A-B, a plasma electrode 402 is placed in proximity to the substrate 401 and a plasma discharge 403 conducted. With reference to FIG. 4C, the plasma discharge 403 creates a treated area 405 is created on the substrate. A support 405 can then be constructed atop the treated area 405. In certain embodiments, another treated area 406 can be created atop supports 404 and object 407 built thereupon. Between adjacent supports the object may experience a small amount of acceptable downward deformation.

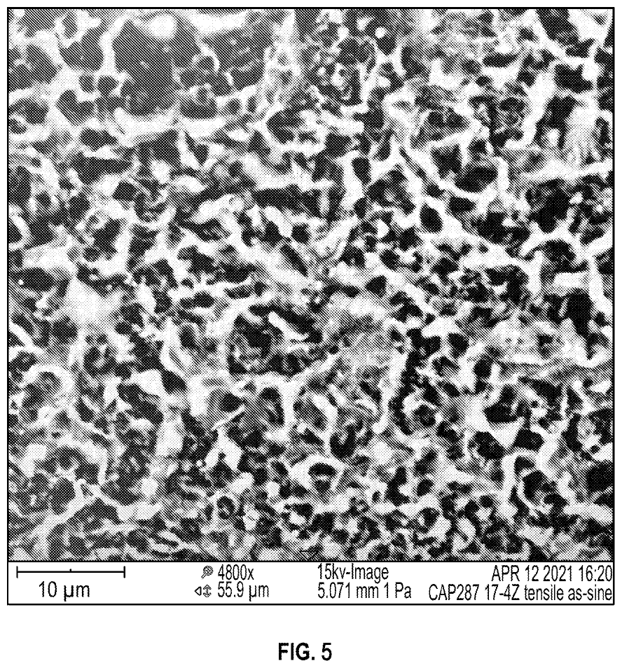

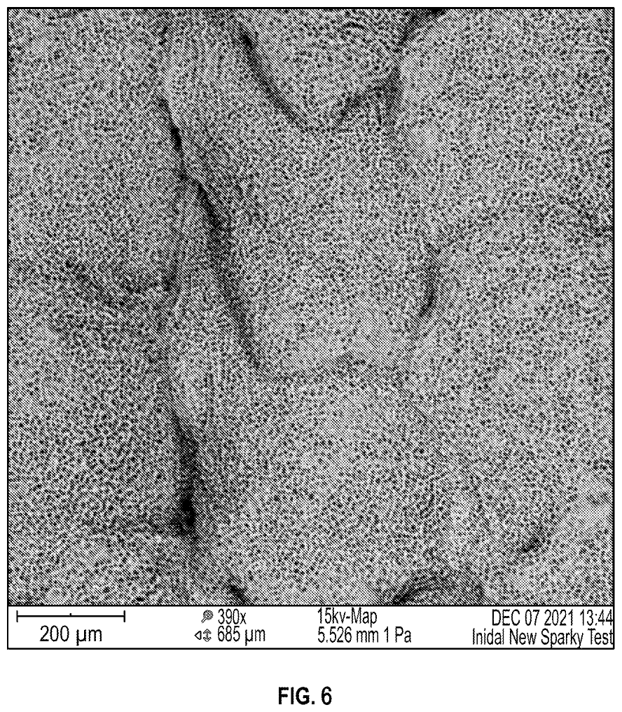

FIG. 5 shows an example of a surface texture created in an aluminum alloy using the plasma discharge technique. This scanning electron micrograph has a 10 micron scale bar in the lower left. As can be seen, a porous structure is created with feature sizes ranging from 1 to 5 microns, although smaller and somewhat larger feature sizes will also work. The texture can be seen to have three dimensional characteristics. FIG. 6 shows an SEM of plasma texture on a more macro scale, although still in an SEM image. In this case, the underlying surface was created by MHD inkjet printing—accounting for the undulating nature of the surface. It can be seen that the plasma texture covers the entire surface, including the valleys between ink-jetted droplets. This is a useful aspect of the disclosed subject matter.

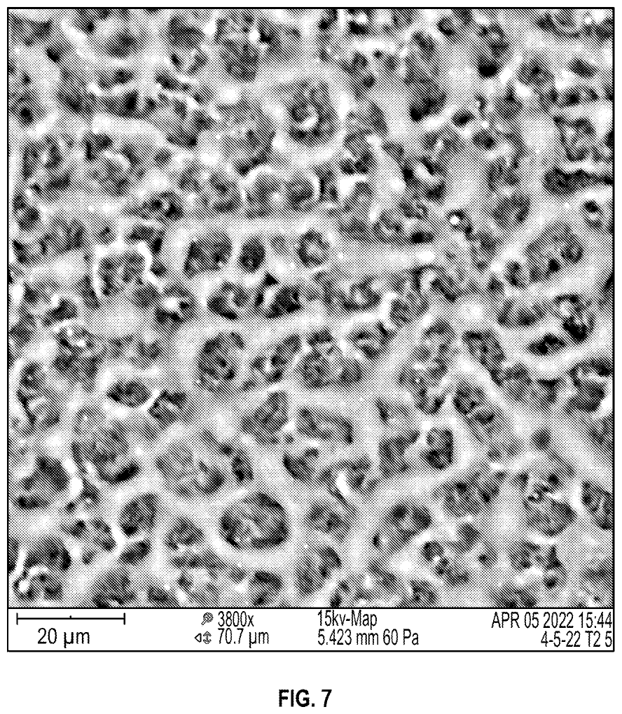

When support columns or structures are jetted onto a surface thus treated, they are found to adhere, but also to be easily broken off, with low forces and without any plastic deformation evident on the surface or the support. This behavior stands in stark contrast to what happens when, for example, a support column that is jetted on a non-treated region is removed. In such a case, the support column must be bent (plastically deformed), rotation it back and forth several times, until the column comes off, typically leaving a stub behind, as will be shown and discussed in FIGS. 7A-P and 8 to follow. In actual use, the situation is much worse in that without the break-away treatment of the currently disclosed subject matter, a support column would be welded at both its bottom and its top, making removal even more difficult. Further, for some part geometries that require supports, the supports will be difficult to access, making it all but impossible to remove, however uncleanly, a support created without the current disclosed subject matter.

Not to be limited by theory, it is hypothesized that one or both of two mechanisms enable this break-away behavior. In mechanism 1, the impinging droplet does bond to the top of the porous, reticulated structure, but the ligaments of this reticulated structure break easily, allowing the material jetted on top of the treated surface to be broken away. In mechanism 2, the outer layer of the treated surface is no longer clean metal and this prevents an incoming droplet of molten aluminum from bonding to it. For example, there may be an oxide layer on the reticulated structure.

In at least one embodiment, the plasma discharge takes place in a one atmosphere argon environment—an environment suitable for the MHD process itself.

The treatment can be used in a variety of geometries and topologies. If support columns are being used, the surface immediately below the first droplet comprising a support tower may be treated. In addition, the surface at the top of the last drop printed in a support tower can also be printed. In this way, after the part is printed, the entire tower can be broken away and removed with the application of a small amount of force. Alternatively, an area of a surface may be treated and the part of interested interest printed atop it and later separated from its support.

The plasma discharge may be created by at least the following two methods: 1) The plasma discharge may be created by discharging a previously charged capacitor using a suitable semiconductor device such as a MOSFET or IGBT. In this case, a single voltage source suffices. 2) Alternatively, the discharge may be initiated by a high voltage discharge, but sustained for its desired duration with a lower voltage source as once the discharge is created, a conductive pathway is established by the plasma. Thus, while hundreds or even in some cases over 1000 volts is needed to initiate the discharge, it can be sustained by a power supply at tens of volts. In the first method, representative parameters include: 0.5 to 3 uF at 1 to 1.3 kV, with a path resistance of 30 to 180 Ohms.

In the second method, representative parameters include: a high voltage capacitor 0.1 microF to 1.0 microF charged with 1 kV, and a low voltage capacitor of 120 microF to 1800 microF changed with 10V to 60V with a path resistance of 0.1 Ohms to 6 Ohms.

The end of the electrode may be ground to an included angle of between 20 and 90 degrees, the end of which can be a fine point but is not necessary for successful surface treatment. The frustum may have a maximum diameter of approximately 1 mm.

Typically the duration of an individual plasma discharge is in the range of 0.25 to 3 milliseconds.

The discharge parameters presented above are for use in a one atmosphere argon environment. Other gasses or pressures will require different parameters as is known in the art. For example, discharge in air will typically require higher voltages as compared to discharges in argon.

The plasma discharge can be either or both AC and/or DC. At least one embodiment includes to use a DC discharge with the polarity such that the electrode is positive with respect to the substrate or part.

The part can be at a wide range of temperatures when the discharge treatment is performed and still produce useful results. For example, for aluminum alloys it has been found that the part can be at a temperature ranging from room temperature to approximately 450° C., but may be higher with different plasma generation parameters. As the temperature of the part increasing gets close to the solidus temperature of the alloy of which it is built, the quality of the surface created diminishes and it performs less well as a break-away surface. FIG. 7 shows a surface texture created when the substrate was at 450° C. Comparing this texture to the texture of FIG. 5., which was created with the substrate at a temperature below 100° C., it can be seen that the texture is less angular and somewhat more globular at the higher temperature. The texture shown in FIG. 7 still functions in the intended break away mode. At a still higher temperature, the texture will become more globular and with coarser features and will function less well as a break-away surface.

It is an aspect of the presently disclosed subject matter to control the temperature of the part within an acceptable range so as to result in the desired break-away properties. Typically, during MHD creation of a part, the part is maintained at an elevated temperature to aid in droplet fusion to the part. In some cases, this elevated temperature can be kept to within the range of temperatures at which plasma discharges create a good break-away surface. In some cases, it may be desirable to maintain the part at a temperature higher than that at which the plasma discharge creates a good break-away surface. In such cases, one option is to lower the part temperature temporarily when making the break away surface. However, this will add to the length of time required to build the part.

Such temperature control of the part applies to the creation of the break-away texture. In some embodiments, such temperature control is also practiced when printing the first droplet on top of the break-away texture, a practice which can further reduce the forces required for break away.

In one embodiment, the local surface temperature of the part or support column being plasma treated is lowered, for example, using a jet of gas. Such a gas jet will very effectively cool the top of a support column, for example. If the gas jet is cool and the flow rate high enough it will also cool the surface of a part sufficiently so that the plasma creates a break away texture even on a more extensive area of part. The same is true of the plasma treatment of the top of a support area. In another embodiment, plasma is used to create a surface texture while the part is at elevated temperature, even though the part is not cool enough for this texture to perform well as a break away texture. A gas jet is then used to cool this texture and plasma re-applied to create a surface which functions well as a break away texture. This is possible, because the porous nature of even an inadequate texture allows the surface to cool more readily in response to a gas jet, for example.

In another embodiment where cooling of a region of part or substrate must be enhanced, it is possible to jet one or two droplets which constitute the base of a support column and then to cool the top of this beginning of a column, for example with a gas jet. The top surface of this column being built can then be plasma treated. This will allow an internal support column, for example to be broken off down to the height of the one or several droplets jetted before the plasma treatment. While this will not leave a clean lower surface, it may be sufficient in some applications.

It has been found that each individual plasma discharge creates a treated region on the part that is roughly circular and can vary in diameter from 0.25 to 1 mm. It is found that when repeated discharges are made without relative motion of the electrode and part, that the circle of texture effect grows with additional pulses. For example in a case where an individual discharge was found to create a circular textured area with a diameter of 0.5 mm, 5 successive discharges produces a spot size of approximately 1.1 mm diameter, and 10 successive discharges produces a spot size of approximately 1.8 mm diameter.

An entire surface can be treated by scanning the electrode over the surface of the part while a series of discharges is made. The frequency of these discharges can be varied. In at least one embodiment, the discharges will be made at a moderately high frequency so as to reduce the amount of time needed to treat a surface. For example, treatment can be performed at a frequency of 100 Hz while scanning the electrode at a speed of 50 mm/s. The spacing between scanned rows is determined in part based on the size of the area of treatment by individual plasma pulses. Typically, the spacing between rows can be 0.5 to 5 mm. Higher frequency discharges and faster traverse times may be possible with higher power voltage sources, for example.

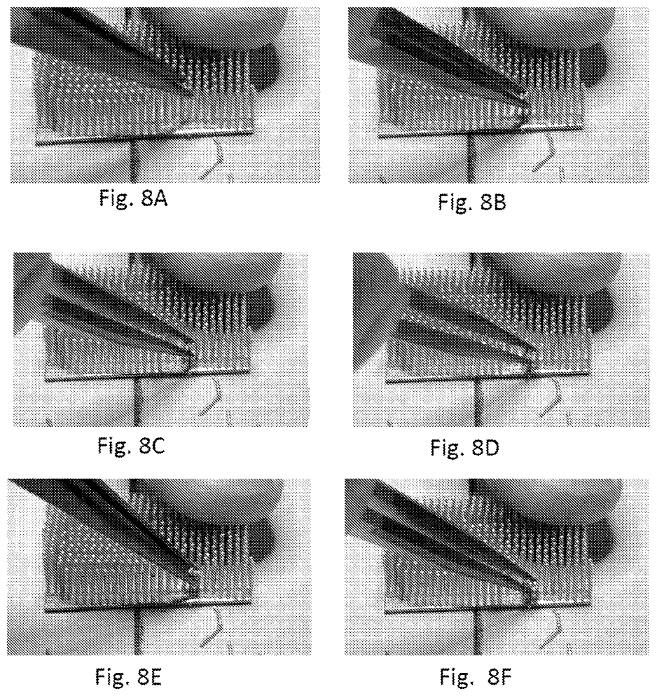

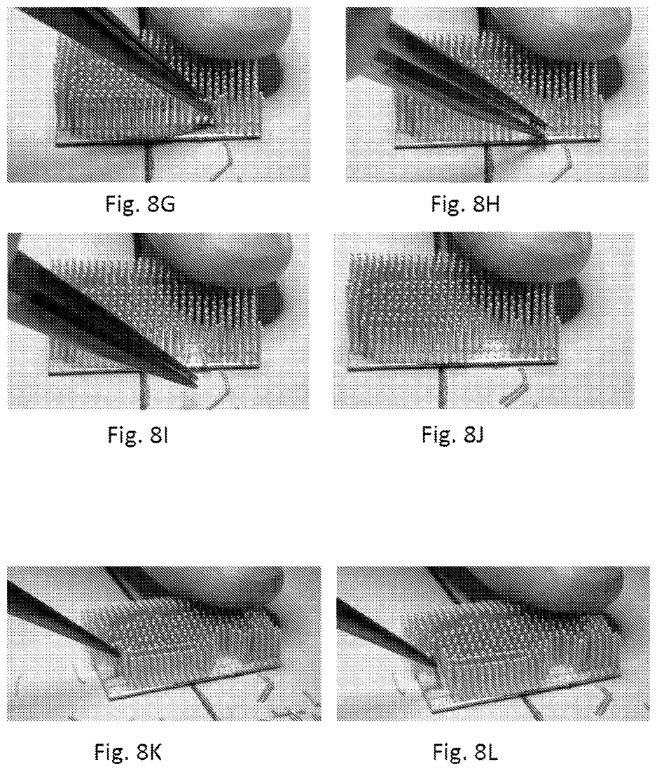

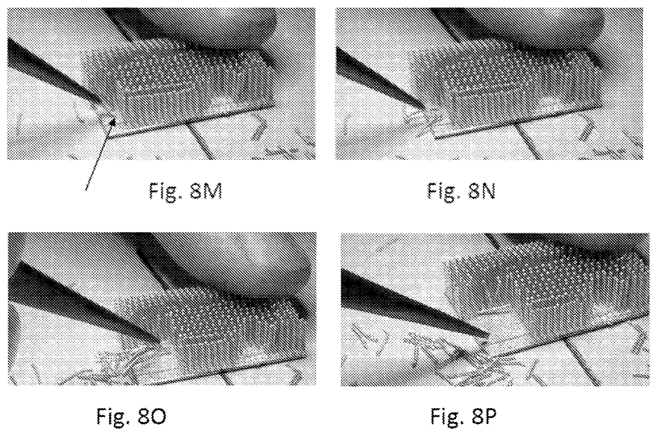

FIGS. 8A-P show images from a video illustrating the difference between removal of support columns from a portion of a substrate which has not received the treatment of the current disclosed subject matter (the right side of the substrate) and from a portion of the same substrate which has received the treatment of the current disclosed subject matter (on the left side of the substrate). The scale of the substrate and the support columns can be seen with reference to the finger-tips and the tweezers shown in the images. The support columns are typical of those that are used, having been created by jetting individual drops of molten aluminum, one atop the previous. The columns are created in close enough proximity to one another so as to intercept and arrest any droplet jetted onto them, even one aimed at the center of the space between support columns. Thus, an object to be built by MHD can be created by first jetting a layer of drops directly onto the top of the plane defined by the support columns and then continuing to jet on top of that newly created plane. The set of columns shown in FIGS. 8A-P would be appropriate to creating the horizontal overhand of a part. In a more general case, the columns would be of different height so as to define the underside of a part with an overhung and undulating surface, for example.

FIGS. 8A-8J, show the removal of columns jetted onto an untreated area of the substrate. To complete the removal, the columns must be bent back and forth several times and torn off the substrate. FIGS. 8A-D show in a sequence a first downward twisting of some columns. In FIGS. 8E-H the columns have been sequentially bent up (FIG. 8E), down (FIG. 8F), up (FIG. 8G), and down (FIG. 8H). FIG. 8I shows that even with all this bending, two columns are still attached to the substrate. FIG. 8J shows the columns cleared. Note that each column has left a small bit—a nub—remaining on the substrate. Such nubs would not be problematic on the build plate, which is discarded. However, similar nubs would be left on the bottom surface of the part built atop the supports and this would be problematic. Further, in some cases, a support column will start on an upward facing surface of the part being printed and will terminate on a downward facing surface of the same part. Such a column, once removed, would leave detrimental nubs on two surfaces of the desired part—at both the base and the top of the removed column.

FIGS. 8K-P show the removal of columns jetted onto a treated area of the substrate. In FIG. 8K the tops of three columns are held in the tweezer. FIG. 8I shows a slight twisting of the columns. In FIG. 8M, the columns are already breaking off the substrate as evidenced by the base of the column in the foreground. The arrow points to the base of this broken-off column. Note—it may make sense to add more arrows to the entire sequence of images. In FIG. 8N it is evident that all three columns have broken off the substrate leaving a clean substrate behind—that is a substrate with no nubs from those three removed columns. FIG. 8O is an image from later in the sequence showing a column which has just broken off. FIG. 8P shows an entire region which has been cleared of columns with no nubs left behind.

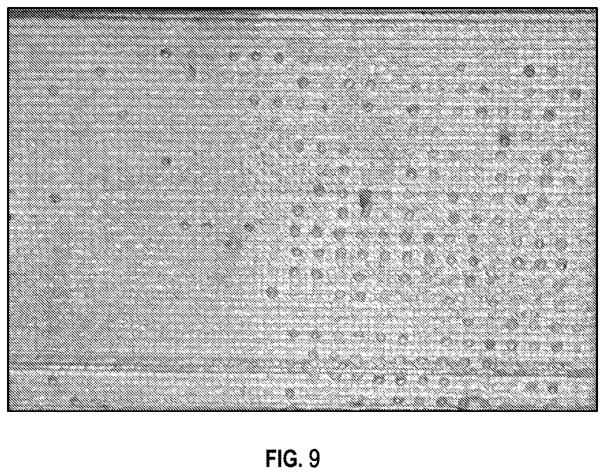

FIG. 9 shows the entire substrate of FIG. 8 cleared of columns. As can be seen, the untreated area on the right is completely full of nubs, while on the treated side on the left, there are very few nubs. The treatment of this substrate was performed with the substrate at an elevated temperature of approximately 500 C., making the clean removal in the treated are even more notable.

In accordance with the present disclosed subject matter, support columns can be removed manually as in FIGS. 8A-P. Support columns can be brushed off, manually, or in an automated fashion. Support columns can be removed by fluid flow, whether or a gas such as air, or a liquid such as water. This is especially appropriate to support columns or pillars within channel in a part. Beads or granules or other media may be used to remove columns by tumbling. Such media can also be added to fluid flows in order to aid in removal. Ultrasonic agitation with or without media can be used. Mechanical shock can be administered, including individual impulses or vibration.

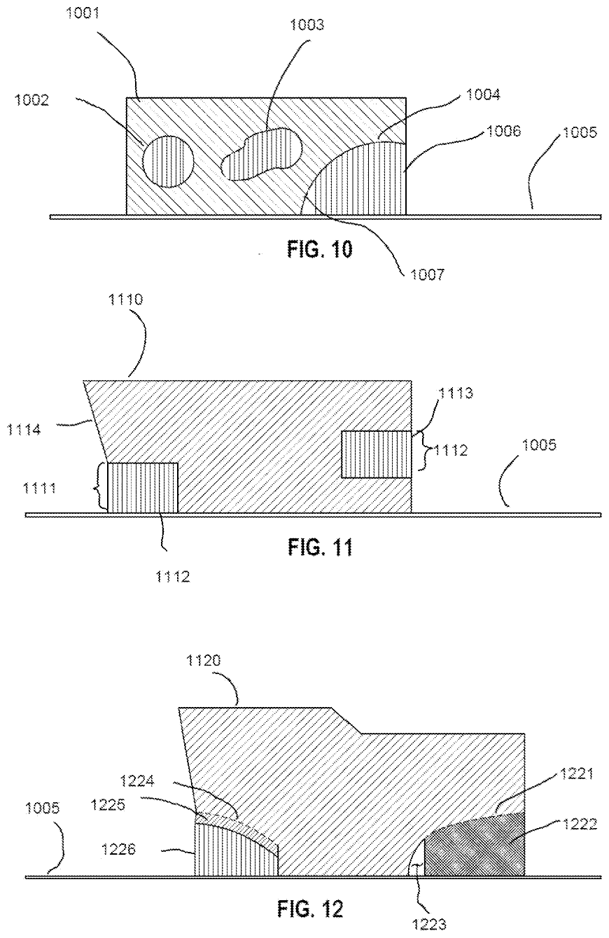

FIG. 10 shows, in two dimensions, examples of support columns for a part 1001 built on a substrate 1005. The part has a circular internal channel 1002 and an irregularly shaped internal channel 1003. The part also has a sweeping overhang 1004. In all three cases, closely spaced support channels are used and the plasma surface treatment would be applied for the top of each support column. The plasma texture would also be applied to the upward facing surface of the part 1001 in the case of channels 1002 and 1003 and to the substrate 1005 in the case of overhang 1004, and the support columns built upon these treated surfaces. In this way, the support columns can be broken away at both their bases and tops. Note that there is a region 1007 of overhang 1004 where support columns are not needed because the angle of the part can be created by self-support without support structures. The same is true in channel 1002.

FIG. 11 shows, in two dimensions, a part 1110 built on a substrate 1005. Overhang 1111 is supported by columns 1112 built from the substrate 1105. Overhang 1113 is supported by columns 1112 built on part 1110 itself. In both cases, break away textures are created at both the base and the top of the columns. Overhang 1114 is close enough to the vertical to be built without supports.

FIG. 12 shows, in two dimensions, a part 1220 built on a substrate 1205. Overhang 1221 is supported by printed support 1222. Note that in region 1223 no support is needed because the part is sufficiently close to vertical to be built without supports. The dotted line between support 1222 and part 1221 is where plasma treatment (performed on support 1222) has been performed to create a break away surface. Overhang 1224 is supported by support 1225 which in turn is supported by column supports 1226. In this instance, support 1225 may have it formed on it a break-away treated surface between it and the part 1220, wherein the support 1225 is not separated from supports 1226 by a breakaway layer. This approach requires less printing as compared with the approach on the right side of FIG. 12. It also makes it easier to locally cool the support structure in order to create more effective break away texture.

The systems, apparatuses, devices, and methods disclosed herein are described in detail by way of examples and with reference to the figures. The examples discussed herein are examples only and are provided to assist in the explanation of the apparatuses, devices, systems, and methods described herein. None of the features or components shown in the drawings or discussed below should be taken as mandatory for any specific implementation of any of these the apparatuses, devices, systems, or methods unless specifically designated as mandatory. For ease of reading and clarity, certain components, modules, or methods may be described solely in connection with a specific figure. In the disclosed subject matter, any identification of specific techniques, arrangements, etc. are either related to a specific example presented or are merely a general description of such a technique, arrangement, etc. Identifications of specific details or examples are not intended to be, and should not be, construed as mandatory or limiting unless specifically designated as such. Any failure to specifically describe a combination or sub-combination of components should not be understood as an indication that any combination or sub-combination is not possible. It will be appreciated that modifications to disclosed and described examples, arrangements, configurations, components, elements, apparatuses, devices, systems, methods, etc. can be made and may be desired for a specific application. Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

Throughout this disclosure, references to components or modules generally refer to items that logically can be grouped together to perform a function or group of related functions. Like reference numerals are generally intended to refer to the same or similar components. Components and modules can be implemented in software, hardware, or a combination of software and hardware. The term “software” is used expansively to include not only executable code, for example machine-executable or machine-interpretable instructions, but also data structures, data stores and computing instructions stored in any suitable electronic format, including firmware, and embedded software. The terms “information” and “data” are used expansively and includes a wide variety of electronic information, including executable code; content such as text, video data, and audio data, among others; and various codes or flags. The terms “information,” “data,” and “content” are sometimes used interchangeably when permitted by context. It is intended that the specification and examples be considered exemplary only.

1. A method of forming break-away supports during additive manufacturing of an object via magnetohydrodynamic (MHD) jetting, comprising
during a process of MHD jetting a plurality of predetermined patterns of a build material to additively manufacture the object, manufacturing at least one break-away support, including:
treating a surface of a substrate to create a first treated surface by performing a plasma discharge in proximity to or against the surface of the substrate; and
constructing at least one break-away support from a support material, wherein a first distal end of the at least one break-away support is interconnected with the first treated surface.

2. The method of claim 1, further comprising:
creating a second treated surface on the object by performing a plasma discharge in proximity to or against the object; and
wherein a second distal end of the at least one break-away support is interconnected with the second treated surface.

3. The method of claim 1, wherein the first treated surface has a texture including re-entrant features.

4. The method of claim 1, wherein the first treated surface has a texture including ligaments and filaments.

5. The method of claim 1, wherein the first treated surface, as a result of the plasma discharge, has a weak mechanical strength.

6. The method of claim 1, wherein the treated surface has a texture including surface features.

7. The method of claim 1 wherein the support material and the build material are the same material.

8. The method of claim 1 wherein the at least one break-away support is a plurality of break away supports, each spaced apart from neighboring break-away supports by a distance sufficiently small such that drops from the MHD jetting that do not land at their intended target are trapped between the neighboring break-away supports as they flow towards the substrate.

9. The method of claim 1 wherein the at least one of the plurality of break-away supports is a plurality of break-away supports configured to have a shape matched to an undulating overhang of the object.

10. A method of creating break-away supports in additive manufacture of metallic objects, comprising:
during an additive manufacturing process, forming an object from a build material and a break-away support from a support material;
wherein forming the object includes depositing a plurality of layers of predetermined patterns of the build material;
wherein the build material and the support the material are one of a same material and a substantially similar material;
wherein forming the break-away support includes treating a support receiving surface to create a surface texture, wherein the surface texture restricts an area of contact between jetted drops of the build material and the part.

11. The method of claim 10 wherein the surface texture has sharp features on a size scale smaller than a footprint of a jetted droplet.

12. The method of claim 11 wherein the sharp features are sized on the order of 0.5 to 10 microns.

13. The method of claim 11 wherein the treatment of the support receiving surface is accomplished via plasma discharge.

14. The method of claim 13 wherein the plasma discharge is from a plasma electrode and the object serves as a second electrode.

15. A MHD jetting apparatus, comprising:
a jetting apparatus body;
a nozzle affixed to the jetting apparatus body, wherein the nozzle includes an entry orifice configured to accept an amount of metallic build material feedstock and an exit orifice;
wherein disposed at least partially within the nozzle are at least two electrodes spaced apart from one another so as to define a firing chamber;
a magnetic source configured to provide a magnetic field substantially orthogonal to and intersecting a flow of current through the electrodes to produce a jetting force on the metallic build material feedstock in the firing chamber;
a robotic system configured to displace the jetting apparatus body relative to a build surface; and
a plasma cleaning electrode configured to direct a plasma treatment in proximity to or onto a surface to create a treated surface to create a surface texture that provides a weak mechanical connection between the treated surface and a break-away support.

16. The system of claim 15 wherein the plasma cleaning electrode includes a tip sharpened to an included angle between 20 and 90 degrees.

17. The system of claim 15 wherein plasma cleaning electrode further includes a charged capacitor.

18. The system of claim 15 wherein the plasma cleaning electrode is configured to initial a discharge at a high voltage followed by a duration discharge at a lower voltage.
